(19) United States
(12) Patent Application Publication
(10) Pub. No.: US 2024/0116769 A1
(43) Pub. Date: Apr. 11, 2024

(54) COMPOUNDS AND METHODS FOR PREPARATION OF ALUMINATES

(71) Applicant: ENTEGRIS, INC., Billerica, MA (US)

(72) Inventors: Scott A. Laneman, Vernon Hills, IL (US); David M. Ermert, Danbury, CT (US); Thomas M. Cameron, Newtown, CT (US)

(21) Appl. No.: 18/378,618

(22) Filed: Oct. 10, 2023

Related U.S. Application Data
(60) Provisional application No. 63/415,155, filed on Oct. 11, 2022.

(51) Int. Cl. C01F 7/48

(52) U.S. Cl. CPC C01F 7/48

(57) ABSTRACT

Methods of the present disclosure include the development of a low temperature, solvent-assistant synthesis of aluminates, such as lithium tetraiodoaluminate (LiAlI₄). The present disclosure includes methods of preparing a compound of formula (I): [M^{+q}][Al(X)₃I]_{q}.

### FIELD

The present disclosure relates to the field of chemistry. More specifically, the present disclosure relates to compounds and methods for preparation of aluminates.

### BACKGROUND

Ball milling can be used to blend solid particles into a blended, fine powder.

### SUMMARY

Methods to prepare aluminates, e.g., LiAlI₄, are partly limited due to hazards associated with synthetic procedures (e.g., toxicity of reagents) or extreme preparative conditions (i.e., high-temperature reactions (e.g., reactions at temperatures exceeding 200° C.)). One example includes heating a mixture of AlI₃ and LiI in CS₂. Potential drawbacks of the method include the toxicity of CS₂. Some of the methods include strongly heating the reaction, e.g., strongly heating with a Bunsen burner. One method of preparation of LiAlI₄ involves heating AlI₃ and LiI together in solid state at elevated temperatures (e.g., temperatures exceeding 200° C.). Some preparation methods include ball milling of solid reactants at 200 rpm and room temperature.

In contrast, methods of the present disclosure include the development of a low temperature, solvent-assisted synthesis of aluminates, such as lithium tetraiodoaluminate (LiAlI₄). Methods of the present disclosure do not require high temperatures (e.g., greater than ˜200° C.). Methods of the present disclosure also do not require the reaction of solids via ball milling or melting. The present disclosure does not require ball milling as the reactants may be in solution, e.g., a slurry. Also, the present disclosure does not require toxic, polar solvents to completely solubilize the reactants (i.e., the starting materials).

In some aspects, the techniques described herein relate to a method including: reacting in a solvent, at a temperature not greater than 200° C., an aluminum (Al) reactant with a reactant M to form a compound of formula (I): [M^{+q}][Al(X)₃I]_{q} (I), wherein: M is chosen from (i) Group 1 metal cations chosen from Li⁺, Na⁺, K⁺, Rb⁺, and Cs⁺; (ii) Group 2 metal cations chosen from Mg²⁺, Ca²⁺, Sr²⁺, and Ba²⁺; and (iii) ammonium, C₁-C₆ alkyl ammonium, or benzyl ammonium cations; and (iii) ammonium, C₁-C₆alkyl ammonium, or benzyl ammonium cations; q is a valence of M and is 1 or 2; and X is chloro, bromo, or iodo.

In some aspects, the techniques described herein relate to a method, wherein M^{+q} is Li⁺.

In some aspects, the techniques described herein relate to a method, wherein q is 1.

In some aspects, the techniques described herein relate to a method, wherein X is iodo.

In some aspects, the techniques described herein relate to a method, wherein the compound of formula (I) is LiAlI₄.

In some aspects, the techniques described herein relate to a method, wherein reacting the aluminum (Al) reactant with the reactant M includes: (i) reacting AlX₃ with M^{+q}X_{q}; or (ii) reacting Al⁰, I₂, and M^{+q}X_{q}.

In some aspects, the techniques described herein relate to a method, wherein reacting Al⁰, I₂, and M^{+q}X_{q} comprises first reacting Al⁰ with I₂ in a solvent to produce in AlI₃ in situ.

In some aspects, the techniques described herein relate to a method, further including reacting the AlI₃ produced in situ with LiI.

In some aspects, the techniques described herein relate to a method, wherein the reacting AlX₃ with M^{+q}X_{q} includes reacting AlI₃ with LiI.

In some aspects, the techniques described herein relate to a method, wherein the reacting AlI₃ with LiI includes reacting AlI₃ with LiI in 1:1 molar equivalents.

In some aspects, the techniques described herein relate to a method, wherein the reacting AlI₃ with LiI includes reacting AlI₃ with LiI at a temperature of less than 150° C.

In some aspects, the techniques described herein relate to a method wherein the compound of formula (I) is generated in situ.

In some aspects, the techniques described herein relate to a method, wherein the aluminum (Al) reactant is AlI₃.

In some aspects, the techniques described herein relate to a method, wherein the reactant M is LiI.

In some aspects, the techniques described herein relate to a method, wherein the solvent is an aromatic hydrocarbon.

In some aspects, the techniques described herein relate to a method, wherein the aromatic hydrocarbon is toluene, xylene, benzene, or chlorobenzene.

In some aspects, the techniques described herein relate to a method, wherein preparing the compound of formula (I) includes preparing the compound of formula (I) at a temperature less than 50° C.

In some aspects, the techniques described herein relate to a method, wherein preparing the compound of formula (I) includes preparing the compound of formula (I) at a temperature less than 40° C.

In some aspects, the techniques described herein relate to a method, wherein the reaction of the aluminum (Al) reactant and the reactant M proceeds in solution at a temperature of 30° C. or above.

In some aspects, the techniques described herein relate to a method, wherein the reaction of the aluminum (Al) reactant and the reactant M proceeds in a slurry at a temperature of 30° C. or above.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting embodiment of two reaction schemes of the present disclosure, in accordance with at least some embodiments of the present disclosure.

FIG. 2 depicts a Lithium (Li) nuclear magnetic resonance (NMR) spectra (⁷Li-NMR spectra), in accordance with some embodiments of the present disclosure.

FIG. 3 depicts a Fourier transform infrared spectroscopy (FTIR) spectroscopy of the formation of LiAlI₄ in toluene, in accordance with some embodiments of the present disclosure.

FIG. 4 depicts a differential scanning calorimetry (DSC) comparison of AlI₃ and LiAlI₄, in accordance with some embodiments of the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise.

In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

As used herein “embedded” means that a first material is distributed throughout a second material.

Methods of the present disclosure include the development of a low temperature, solvent-assistant synthesis of aluminates, such as lithium tetraiodoaluminate (LiAlI₄). Methods of the present disclosure do not require high temperatures (e.g., greater than ˜200° C.). Methods of the present disclosure also do not require ball milling as the reactants may be in solution, e.g., a slurry.

The present disclosure includes methods of preparing a compound of formula (I):

[M^{+q}][Al(X)₃I]_{q} (I).

The method includes reacting an aluminum (Al) reactant with a reactant M to form the compound of formula (I). M is chosen from (i) Group 1 metal cations chosen from Li⁺, Na⁺, K⁺, Rb⁺, and Cs⁺, (ii) Group 2 metal cations chosen from Mg²⁺, Ca²⁺, Sr²⁺, and Ba²⁺; and (iii) ammonium, C₁-C₆alkyl ammonium, or benzyl ammonium cations; q is a valence of M and is 1 or 2; and X is chloro, bromo, or iodo. In some embodiments, the reactant M is a metal or behaves like a metal (e.g., ammonium, C₁-C₆alkyl ammonium, and/or benzyl ammonium cations).

In some embodiments, compounds of formula (I) include LiAl(I)₄, NaAl(I)₄, KAl(I)₄, Mg[Al(I)₄]₂, Ca[Al(I)₄]₂, LiAl(Cl)₃I, LiAlCl(I)₃, NaAl(Cl)₃I, NaAlCl(I)₃, KAl(Cl)₃I, KAlCl(I)₃, Mg[Al(Cl)₃I]₂, Mg[Al(Cl)(I)₃]₂, Ca[Al(Cl)₃I]₂, Ca[Al(Cl)(I)₃]₂, NH₄Al(I)₄, NH₄Al(Cl)₃I, NH₄Al(Cl)(I)₃, NaAl₂I₇, NaAl₃I₁₀, and Al(I)₃.

In some embodiments, M is chosen from cations such as (CH₃)₄N⁺, (CH₃CH₂)₄N⁺, (CH₃CH₂CH₂)₄N⁺, and (CH₃CH₂CH₂CH₂)₄N⁺.

In some embodiments, the compound of formula (I) can be referred to as an aluminate and can be generated by reaction in solution using 1:1 molar ratios of reactants (or 2:1 in the case of divalent Group 2 metal cations). By way of example, an LiAl(I)₄ aluminate can be prepared by mixing LiI and Al(I)₃ in solution when combined in a 1:1 molar ratio. In some embodiments, mild heating may be used while mixing the reactants. Mild heating may include increasing the temperature to a maximum of a boiling point of a solvent for the solution.

In some embodiments, the solvent of is an aromatic hydrocarbon. In some embodiments, the aromatic hydrocarbon is toluene, xylene, benzene, chlorobenzene, or combinations thereof. In some embodiments, the solvent may be toluene. A boiling point of toluene is 115° C. In some embodiments, when the solvent includes toluene, the method may include heating up to 115° C. In some embodiments, the solvent may be benzene. The boiling point of benzene is 80° C. In some embodiments, when the solvent includes benzene, the method may include heating up to 80° C. In some embodiments, the solvent may be chlorobenzene. The boiling point of chlorobenzene is 132° C. In some embodiments, when the solvent includes chlorobenzene, the method may include heating up to 132° C. In some embodiments, the solvent may be xylene. The boiling point of xylene isomers includes 139° C. for meta-xylene, 144° C. for ortho-xylene, and 138.4° C. for para-xylene. In some embodiments, when the solvent includes xylene isomers, the method may include heating up to 138.4° C., 139° C., or 144° C. In some embodiments, mild heating may include increasing the temperature to a maximum of a boiling point of a solvent (as described herein) for the solution.

Alternately, in situ formation of LiAlI₄ can be prepared via a reaction of Al⁰+I₂ in a solvent followed by LiI addition.

In some embodiments, the aluminum (Al) reactant is aluminum triiodide. In some embodiments, the displacement reaction occurs in the presence of aluminum triiodide alone; such aluminum triiodide can be used directly as the aluminum (Al) reactant or can be generated in situ by the reaction of aluminum metal with iodine.

In some embodiments, Al(X)₃ from formula (I), when X is chloro, bromo, (or iodo) can be utilized in conjunction with a Group I or Group 2 iodide. In such cases, the aluminate species can be generated in situ by reacting, for example AlCl₃ with MgI₂, the latter of which can be formed in situ by the reaction of magnesium metal with iodine.

In some embodiments, reacting the aluminum (Al) reactant with the reactant M includes:
(i) reacting AlX₃ with M^{+q}X_{q}; or
(ii) reacting Al⁰, I₂, and M^{+q}X_{q}.

In some embodiments, reacting Al⁰, I₂, and M^{+q}X_{q} comprises first reacting Al⁰ with I₂ in a solvent to produce in AlI₃ in situ. The method further includes subsequently reacting the AlI₃ produced in situ with LiI.

In some embodiments, reacting AlX₃ with M^{+q}X_{q} includes reacting AlI₃ with LiI. In some embodiments, reacting AlI₃ with LiI comprises reacting AlI₃ with LiI in 1:1 molar equivalents.

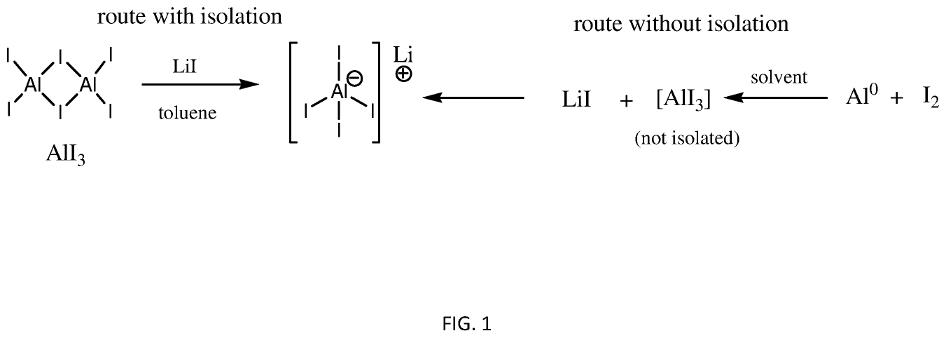

FIG. 1 depicts a non-limiting embodiment of two reaction schemes of the present disclosure, in accordance with at least some embodiments of the present disclosure. In FIG. 1, the route with isolation displays an embodiment of the present disclosure for the reaction mechanism of (i) reacting AlX₃ with M^{+q}X_{q}: reacting AlI₃ with LiI. In FIG. 1, the route without isolation displays an embodiment of the present disclosure for the reaction mechanism of (ii) reacting Al⁰, I₂, and M^{+q}X_{q}: first reacting Al⁰ and I₂, and then reacting the product of Al⁰ and I₂ (the product being AlI₃) with LiI.

In some embodiments, while reacting AlI₃ with LiI, the method of the present disclosure includes heating AlI₃ and LiI to a temperature of less than 150° C. In some embodiments, the method of present disclosure includes heating to a maximum temperature that is equal to a boiling point of the solvent.

In some embodiments, the compound of formula (I) is generated in situ. In some embodiments, the aluminum (Al) reactant is AlI₃. In some embodiments, the reactant M is LiI. In some embodiments, reacting the aluminum (Al) reactant with the reactant M includes reacting the aluminum (Al) reactant with the reactant M in a solvent.

In some embodiments, preparing the compound of formula (I) comprises reacting an aluminum (Al) reactant with a reactant M at a temperature of less than 150° C., less than 100° C., less than 90° C., less than 80° C., less than 70° C., less than 60° C., less than 50° C., less than 45° C., less than 40° C., or less than 30° C. In some embodiments, the maximum temperature for preparing the compound of formula (I) is the boiling point of solvent.

In some embodiments, the reaction of the aluminum (Al) reactant and the reactant M occurs at temperature of 30° C. or above and is in solution or a slurry. In some embodiments, the reaction of the aluminum (Al) reactant and the reactant M occurs at temperature of less than about 150° C. and is in solution or a slurry. In some embodiments, the reaction of the aluminum (Al) reactant and the reactant M occurs at temperature of less than about 50° C. and is in solution or a slurry. In some embodiments, the reaction of the aluminum (Al) reactant and the reactant M at temperature from about 30° C. to about 150° C. and is in solution or a slurry. In some embodiments, the reaction of the aluminum (Al) reactant and the reactant M occurs at temperature from about 40° C. to about 60° C. and is in solution or a slurry. In some embodiments, the reaction of the aluminum (Al) reactant and the reactant M occurs at temperature of less than about 60° C. and is in solution or a slurry.

### EXAMPLES

### Example 1

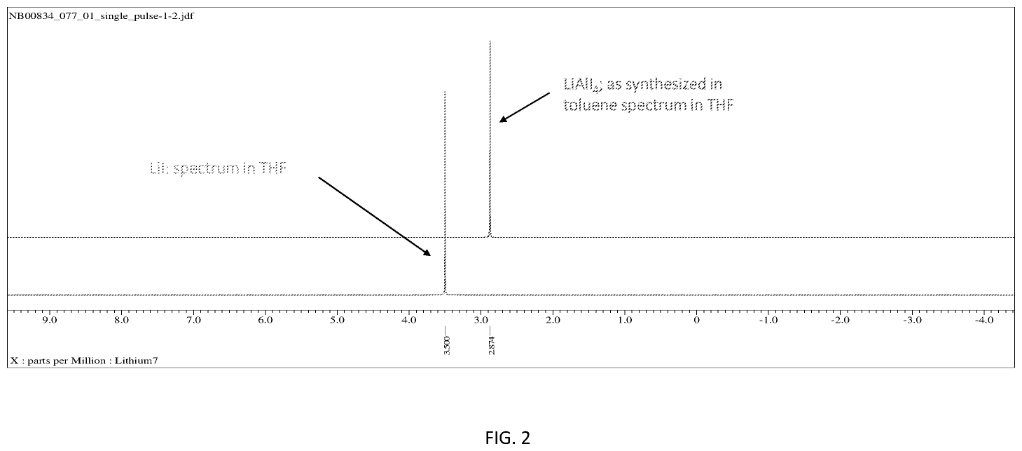

FIG. 2 depicts a ⁷Li-NMR spectra, in accordance with some embodiments of the present disclosure. More specifically, FIG. 2 depicts the ⁷Li-NMR spectra recorded on a tetrahydrofuran (THF) solution of LiAlI₄ synthesized using the described solvothermal approach. The reaction occurred in toluene.

The ⁷Li-NMR experiments performed on THF solutions of as-synthesized LiAlI₄ are consistent with consumption of LiI (3.5 ppm) and generation of LiAlI₄ (2.8 ppm). Additionally, AlI₃ is reactive with THF.

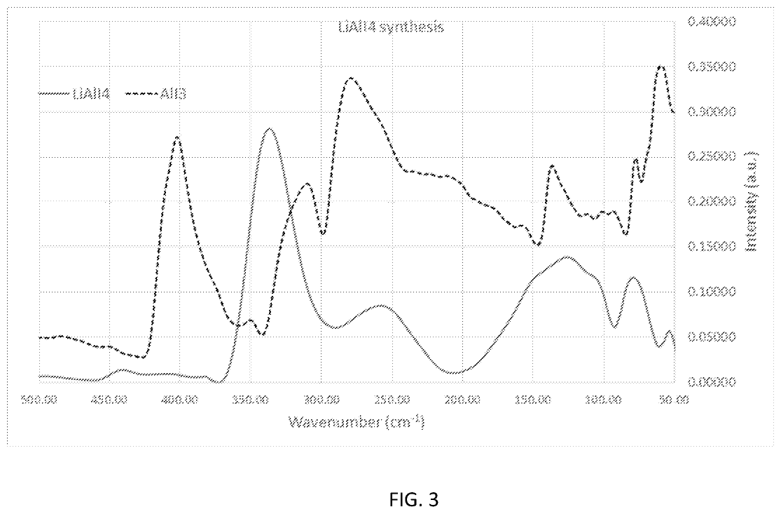

FIG. 3 depicts a Fourier transform infrared spectroscopy (FTIR) of the formation of LiAlI₄ in toluene, in accordance with some embodiments of the present disclosure.

FTIR experiments carried out on solid-state samples of LiAlI₄ produced from the previously described solvothermal synthesis method display a new vibration at ˜340 cm⁻¹, whereby, AlI₃ (˜400 cm⁻¹) is not observed. Taken together, these data are consistent with consumption of AlI₃ and generation of LiAlI₄.

### Example 2

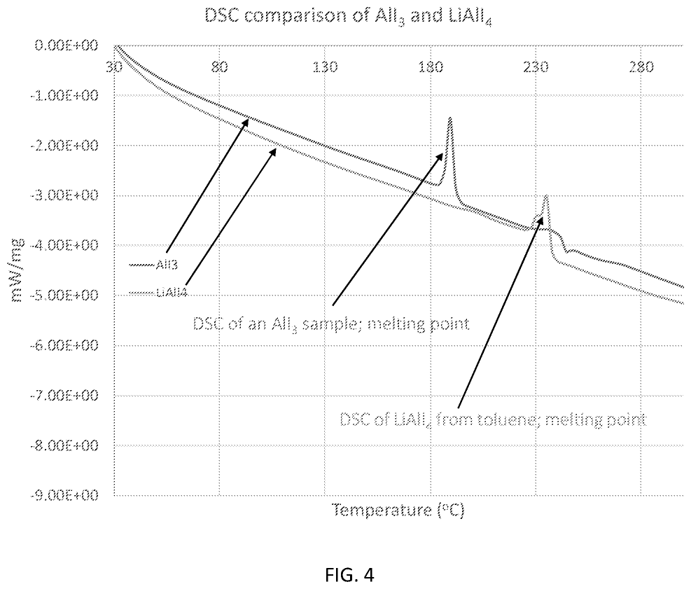

FIG. 4 depicts a differential scanning calorimetry (DSC) comparison of AlI₃ and LiAlI₄, in accordance with some embodiments of the present disclosure.

The melting points of AlI₃ (189.5° C.) and LiAlI₄ (235.2° C.), established using DSC, correspond well to previously reported literature values (235.9° C. for LiAlI₄).

Reaction products obtained from the combination of AlI₃ and LiI in toluene contain no AlI₃ by DSC analysis and are consistent with the consumption of AlI₃ and formation of LiAlI₄.

### Example 3

Solvothermal Synthesis of LiAlI₄

In a nitrogen-filled glovebox, AlI₃ (0.300 g, 0.736 mmol) and LiI (0.0984 g, 0.736 mmol) were placed in a 40 mL vial equipped with a magnetic stir bar and diluted with toluene (8 mL) to form a slightly cloudy light-yellow solution, which was stirred at room temperature for 3.5 hours. At this point, the solvent was removed under reduced pressure to yield LiAlI₄ in quantitative yield as an off-white solid. The product's melting point (235.2° C.) was obtained via differential scanning calorimetry (DSC) and was consistent to that reported in the literature. ⁷Li-NMR (155 MHz, THF, 298K): 2.874 ppm; ²⁷Al-NMR (104 MHz, C₇D₈, 298K); −20.0 ppm. FTIR (diamond stage); 340 cm⁻¹.

Aspects

Various Aspects are described below. It is to be understood that any one or more of the features recited in the following Aspect(s) can be combined with any one or more other Aspect(s).
Aspect 1. A method comprising: reacting in a solvent, at a temperature not greater than 200° C., an aluminum (Al) reactant with a reactant M to form a compound of formula (I): [M^{+q}][Al(X)₃I]_{q} (I), wherein: M is chosen from (i) Group 1 metal cations chosen from Li⁺, Na⁺, K⁺, Rb⁺, and Cs⁺; (ii) Group 2 metal cations chosen from Mg²⁺, Ca²⁺, Sr²⁺, and Ba²⁺; and (iii) ammonium, C₁-C₆alkyl ammonium, or benzyl ammonium cations; and (iii) ammonium, C₁-C₆alkyl ammonium, or benzyl ammonium cations; q is a valence of M and is 1 or 2; and X is chloro, bromo, or iodo.
Aspect 2. The method of Aspect 1, wherein M^{+q} is Li⁺.
Aspect 3. The method of Aspect 1 or 2, wherein q is 1.
Aspect 4. The method as in any one of the preceding Aspects, wherein X is iodo.
Aspect 5. The method as in any one of the preceding Aspects, wherein the compound of formula (I) is LiAlI₄.
Aspect 6. The method as in any one of the preceding Aspects, wherein reacting the aluminum (Al) reactant with the reactant M includes: (i) reacting AlX₃ with M^{+q}X_{q}; or (ii) reacting Al⁰, I₂, and M^{+q}X_{q}.
Aspect 7. The method of Aspect 6, wherein reacting Al⁰, I₂, and M^{+q}X_{q} comprises first reacting Al⁰ with I₂ in a solvent to produce in AlI₃ in situ.
Aspect 8. The method of Aspect 7, further including reacting the AlI₃ produced in situ with LiI.
Aspect 9. The method of Aspect 6, wherein the reacting AlX₃ with M^{+q}X_{q} includes reacting AlI₃ with LiI.
Aspect 10. The method of Aspect 9, wherein the reacting AlI₃ with LiI includes reacting AlI₃ with LiI in 1:1 molar equivalents.
Aspect 11. The method of Aspect 9, wherein the reacting AlI₃ with LiI includes reacting AlI₃ with LiI at a temperature of less than 150° C.
Aspect 12. The method as in any one of the preceding Aspects, wherein the compound of formula (I) is generated in situ.
Aspect 13. The method as in any one of the preceding Aspects, wherein the aluminum (Al) reactant is AlI₃.
Aspect 14. The method as in any one of the preceding Aspects, wherein the reactant M is LiI.
Aspect 15. The method as in any one of the preceding Aspects, wherein the solvent is an aromatic hydrocarbon.
Aspect 16. The method of Aspect 15, wherein the aromatic hydrocarbon is toluene, xylene, benzene, or chlorobenzene.
Aspect 17. The method as in any one of the preceding Aspects, wherein preparing the compound of formula (I) includes preparing the compound of formula (I) at a temperature less than 50° C.
Aspect 18. The method as in any one of the preceding Aspects, wherein preparing the compound of formula (I) includes preparing the compound of formula (I) at a temperature less than 40° C.
Aspect 19. The method as in any one of the preceding Aspects, wherein the reaction of the aluminum (Al) reactant and the reactant M proceeds in solution at a temperature of 30° C. or above.
Aspect 20. The method as in any one of the preceding Aspects, wherein the reaction of the aluminum (Al) reactant and the reactant M proceeds in a slurry at a temperature of 30° C. or above.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
reacting in a solvent, at a temperature not greater than 200° C., an aluminum (Al) reactant with a reactant M to form a compound of formula (I):
[M^{+q}][Al(X)₃I]_{q} (I),
wherein:
M is chosen from (i) Group 1 metal cations chosen from Li⁺, Na⁺, K⁺, Rb⁺, and Cs⁺; (ii) Group 2 metal cations chosen from Mg²⁺, Ca²⁺, Sr²⁺, and Ba²⁺; and (iii) ammonium, C₁-C₆ alkyl ammonium, or benzyl ammonium cations;
q is a valence of M and is 1 or 2; and
X is chloro, bromo, or iodo.

2. The method of claim 1, wherein M^{+q} is Li⁺.

3. The method of claim 1, wherein q is 1.

4. The method of claim 1, wherein X is iodo.

5. The method of claim 1, wherein the compound of formula (I) is LiAlI₄.

6. The method of claim 1, wherein reacting the aluminum (Al) reactant with the reactant M comprises:
(i) reacting AlX₃ with M^{+q}X_{q}; or
(ii) reacting Al⁰, I₂, and M^{+q}X_{q}.

7. The method of claim 6, wherein reacting Al⁰, I₂, and M^{+q}X_{q} comprises first reacting Al⁰ with I₂ in a solvent to produce in AlI₃ in situ.

8. The method of claim 7, further comprising reacting the AlI₃ produced in situ with LiI.

9. The method of claim 6, wherein the reacting AlX₃ with M^{+q}X_{q} comprises reacting AlI₃ with LiI.

10. The method of claim 9, wherein the reacting AlI₃ with LiI comprises reacting AlI₃ with LiI in 1:1 molar equivalents.

11. The method of claim 9, wherein the reacting AlI₃ with LiI comprises reacting AlI₃ with LiI at a temperature of less than 150° C.

12. The method of claim 1, wherein the compound of formula (I) is generated in situ.

13. The method of claim 1, wherein the aluminum (Al) reactant is AlI₃.

14. The method of claim 1, wherein the reactant M is LiI.

15. The method of claim 1, wherein the solvent is an aromatic hydrocarbon.

16. The method of claim 15, wherein the aromatic hydrocarbon is toluene, xylene, benzene, or chlorobenzene.

17. The method of claim 1, wherein preparing the compound of formula (I) comprises preparing the compound of formula (I) at a temperature less than 50° C.

18. The method of claim 1, wherein preparing the compound of formula (I) comprises preparing the compound of formula (I) at a temperature less than 40° C.

19. The method of claim 1, wherein the reaction of the aluminum (Al) reactant and the reactant M proceeds in solution at a temperature of 30° C. or above.

20. The method of claim 1, wherein the reaction of the aluminum (Al) reactant and the reactant M proceeds in a slurry at a temperature of 30° C. or above.
